(19) United States
(12) Patent Application Publication
(10) Pub. No.: US 2018/0280231 A1
(43) Pub. Date: Oct. 4, 2018

(54) INVASIVE SHOCK WAVE APPLICATOR FOR APPLYING SHOCK WAVES SIDEWAYS

(71) Applicant: LITE-MED INC., Taipei City (TW)

(72) Inventors: CHIA-CHI LIN, TAIPEI CITY (TW); YUNG-CHEN SU, TAIPEI CITY (TW); PO-HSIANG KUO, TAIPEI CITY (TW)

(21) Appl. No.: 15/475,732

(22) Filed: Mar. 31, 2017

(51) Int. Cl. A61H 23/00

(52) U.S. Cl. CPC A61H 23/008

(57) ABSTRACT

An invasive shock wave applicator for applying shock waves sideways includes a bar-shaped invasive member and a disk. The invasive member defines a lateral side, has a first end with a recess extending inward from the lateral side, and is provided with a shock wave transmission member detachably sealing the opening of the recess. The disk is embedded in the invasive member; divides the recess into first and second receiving rooms, which are adjacent to and away from the shock wave transmission member respectively; and is provided with a vibration plate adjacent to the first receiving room and facing the shock wave transmission member. The first receiving room is filled with a shock wave transmission medium. Shock waves propagate toward the lateral side of the invasive member to facilitate the performance of an invasive shock wave treatment in a human cavity of the human body.

### BACKGROUND OF THE INVENTION

### 1. Technical Field

The present invention relates to an invasive shock wave applicator that applies shock waves sideways. More particularly, the invention relates to an invasive shock wave applicator that emits shock waves from a lateral side of the applicator and is therefore suitable for use in a human cavity of the human body.

### 2. Description of Related Art

As is well known in the art, shock waves can be put to medical use. In addition to being focused to fragment stones in the urinary system, shock waves can be used in extracorporeal shock wave treatments to alleviate pain, which treatments involve applying high-energy shock waves to an area in chronic pain to promote regeneration of blood vessels, and consequently tissue regeneration and repair, with a view to pain relief. For example, shock waves can be used to treat adhesive capsulitis (generally known as frozen shoulder), lateral epicondylitis (tennis elbow), and plantar fasciitis (jogger's heel).

However, the conventional shock wave application for pain relief are typically intended only for relatively shallow muscles or bones in the human body. That is to say, the shock wave energy generated by such applications cannot reach, let alone treat, relatively deep muscles or bones, simply considering the loss of energy during shock wave propagation.

### BRIEF SUMMARY OF THE INVENTION

In light of the above, the inventor of the present invention conducted extensive research and experiment and finally succeeded in developing an invasive shock wave applicator for applying shock waves sideways. The invasive shock wave applicator is configured to enter a human cavity of the human body and perform shock wave treatments where shock waves generated by its conventional counterparts are difficult to reach. The invasive shock wave applicator for applying shock waves sideways includes an invasive member and a disk. The invasive member extends in an axial direction, is in the shape of a bar, and includes a lateral side and a first end. The first end is provided with a recess extending inward from the lateral side. The recess has an opening on the lateral side. The invasive member further has a second end opposite the first end. The second end is formed with a first passage and a second passage, both in communication with the recess. A shock wave transmission member detachably seals the opening of the recess. The disk is embedded in the invasive member, lies in the recess, and divides the recess into a first receiving room adjacent to the shock wave transmission member and a second receiving room away from the shock wave transmission member. The first passage is in communication with the first receiving room, and the second passage, with the second receiving room. The disk is provided with a vibration plate, which is adjacent to the first receiving room and faces the shock wave transmission member. The direction in which the vibration plate faces the shock wave transmission member is defined as a first direction. The first direction and the axial direction form an included angle. The first receiving room is filled with a shock wave transmission medium, which can circulate through the first passage. An electrical connection member extends through the second passage and is electrically connected to the disk.

Preferably, the included angle ranges from 1 degree to 135 degrees.

Preferably, the included angle is substantially 90 degrees.

Preferably, the included angle is substantially 45 degrees.

Preferably, the invasive member further includes a middle section connected between the first end and the second end, and the first end includes a convex block and a fixing block. The convex block is integrally connected with the middle section. The fixing block is detachably assembled to the convex block. The convex block is penetrated by a channel and thus defines the opening and an aperture opposite the opening. The aperture is provided with an annular part. The disk is provided at the annular part and covers the aperture. The disk is pressed tightly against the annular part when the fixing block is assembled to the convex block.

Preferably, the direction in which the aperture faces the opening is substantially at a 90-degree angle with respect to the axial direction such that the included angle is substantially 90 degrees.

Preferably, the direction in which the aperture faces the opening is substantially at a 45-degree angle with respect to the axial direction such that the included angle is substantially 45 degrees.

Preferably, the shock wave transmission member is made of silicone.

Preferably, the shock wave transmission medium is water.

Preferably, the first end further includes an annular lateral cover fixedly provided at the opening, and the shock wave transmission member is fixedly provided between the annular lateral cover and the opening.

The foregoing technical features can produce the following effects:

1. With shock waves propagating toward the lateral side of the invasive member, the invasive shock wave applicator is suitable for use in human cavitys of the human body to perform invasive shock wave treatments.

2. An operator can easily adjust the position and direction the shock wave transmission member faces, in order to press the shock wave transmission member tightly against the wall of a human cavity of the human body and thereby transmit shock waves effectively into the human body to treat the area to be treated.

3. With the fixing block fixing the disk to the convex block, the first end of the invasive member, which is integrally connected with the middle section of the invasive member, is in fact detachably assembled from the fixing block, the disk, and the convex block, forming a shock wave generating unit suitable for use in a human cavity of the human body to perform invasive shock wave treatments. The assembled structure also facilitates component replacement and reduces the complexity of maintenance.

4. The shock wave transmission medium in the first receiving room not only transmits shock waves, but also provides enhanced heat dissipation by carrying the heat generated by the disk during operation away from the invasive shock wave applicator through the first passage.

### BRIEF DESCRIPTION OF THE SEVERAL VIEWS OF THE DRAWINGS

FIG. 1 is an exploded sectional view of the invasive shock wave applicator in an embodiment of the present invention, wherein the shock wave applicator is configured to apply shock waves sideways;

FIG. 2 is an assembled sectional view of the invasive shock wave applicator in FIG. 1;

FIG. 3 is a partial front view of the invasive shock wave applicator in FIG. 1;

FIG. 4 is a partial rear view of the invasive shock wave applicator in FIG. 1;

FIG.5 schematically shows the invasive shock wave applicator in FIG. 1 used in a gynecological treatment;

FIG. 6 is an exploded sectional view of the invasive shock wave applicator in another embodiment of the present invention, wherein the shock wave applicator is also configured to apply shock waves sideways; and

FIG. 7 is an assembled sectional view of the invasive shock wave applicator in FIG. 6.

### DETAILED DESCRIPTION OF THE INVENTION

The present invention incorporates the technical features described above into an invasive shock wave applicator that applies shock waves sideways. The major effects of the invasive shock wave applicator are detailed below with reference to some illustrative embodiments of the invention.

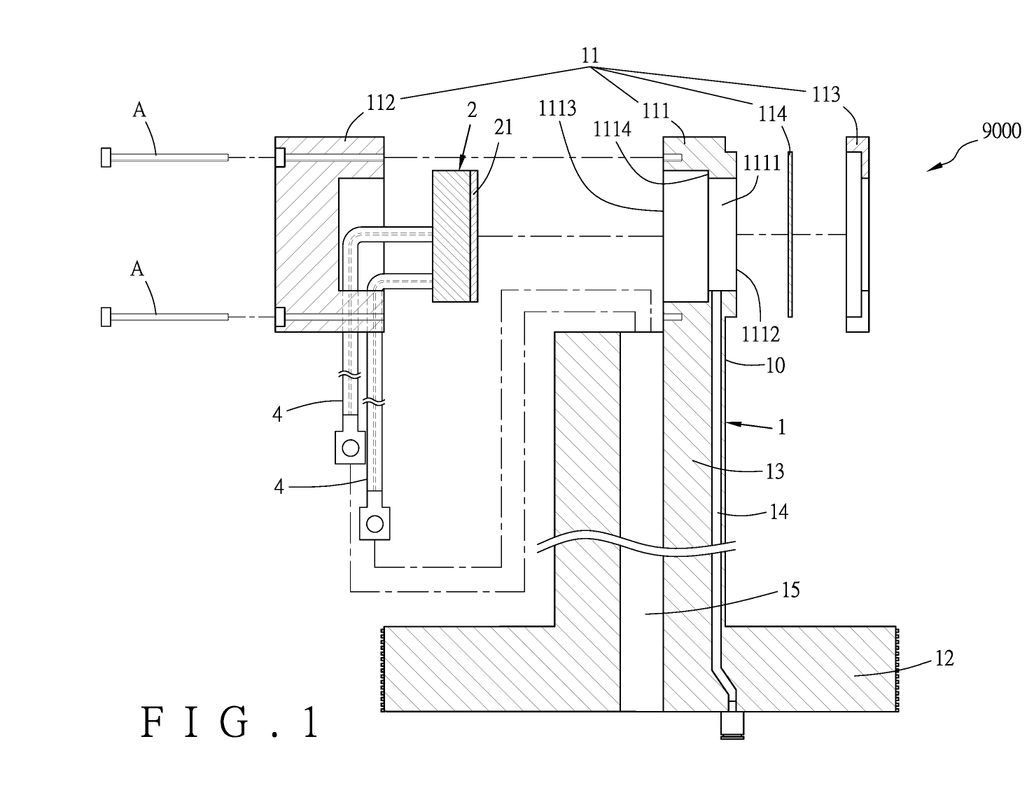

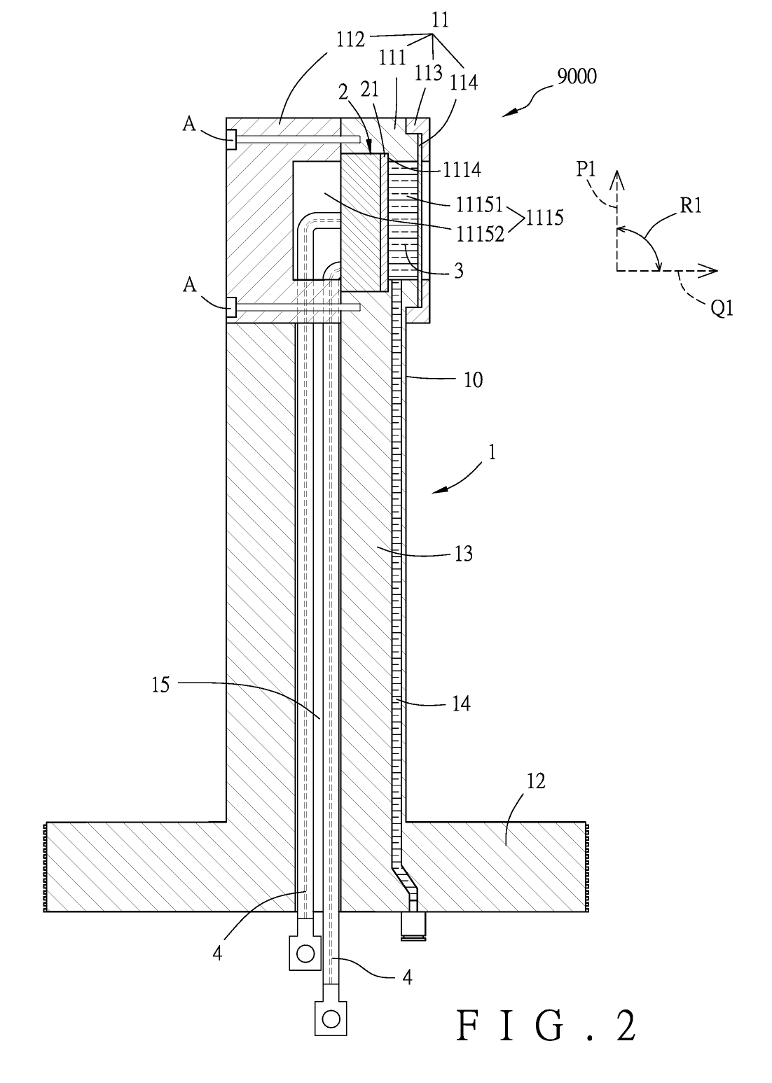

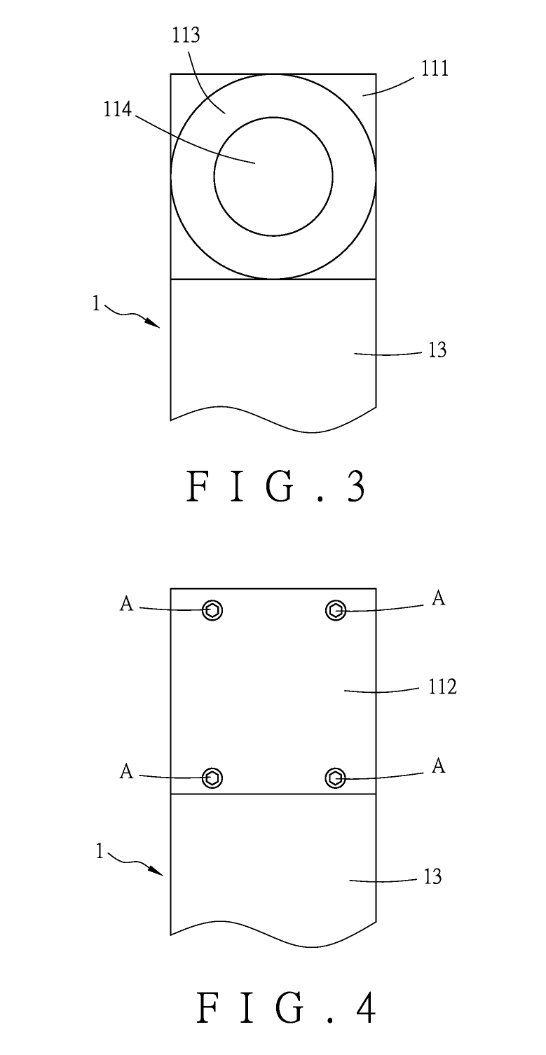

In an embodiment as shown in FIG. 1, FIG. 2, FIG. 3, and FIG. 4, the invasive shock wave applicator 9000 for applying shock waves sideways includes an invasive member 1 and a disk 2. The invasive member 1 extends in an axial direction P1 and is in the shape of a bar. The invasive member 1 includes a lateral side 10 and defines a first end 11, a second end 12, and a middle section 13. The middle section 13 is connected between the first end 11 and the second end 12. The first end 11 includes a convex block 111 and a fixing block 112. The fixing block 112 is configured to be assembled to the convex block 111 in a detachable manner. The convex block 111 is integrally connected with the middle section 13, is penetrated by a channel 1111, and thus defines an opening 1112 and an aperture 1113 opposite the opening 1112. The opening 1112 is located on the lateral side 10. The aperture 1113 is provided with an annular part 1114.

With continued reference to FIG. 1 to FIG. 4, the disk 2 is provided at the annular part 1114 and covers the aperture 1113. The fixing block 112 is assembled to the convex block 111 via locking pins A and thereby presses the disk 2 tightly against the annular part 1114. Once the fixing block 112 is assembled to the convex block 111, the channel 1111 is expanded into a recess 1115 (see FIG. 2), and the disk 2 is embedded in the invasive member 1 and lies in the recess 1115. The first end 11 further includes an annular lateral cover 113 fixedly yet detachably provided at the opening 1112. A shock wave transmission member 114 is fixedly yet detachably provided between the annular lateral cover 113 and the opening 1112 and thus seals the opening 1112. The disk 2 divides the recess 1115 into a first receiving room 11151 adjacent to the shock wave transmission member 114 and a second receiving room 11152 away from the shock wave transmission member 114. The second end 12 of the invasive member 1 is formed with a first passage 14 and a second passage 15. The first passage 14 is in communication with the first receiving room 11151 while the second passage 15 is in communication with the second receiving room 11152. The disk 2 is provided with a vibration plate 21 adjacent to the first receiving room 11151 and facing the shock wave transmission member 114. The direction in which the vibration plate 21 faces the shock wave transmission member 114 is defined as a first direction Q1. The first direction Q1 and the axial direction P1 form an included angle R1.

With continued reference to FIG. 1 to FIG. 4, the first receiving room 11151 is filled with a shock wave transmission medium 3, which can circulate through the first passage 14. An electrical connection member 4 extends through the second passage 15 and is electrically connected to the disk 2. In this embodiment, the direction in which the aperture 1113 faces the opening 1112 is substantially perpendicular to (i.e., at a 90-degree angle with respect to) the axial direction P1 of the invasive member 1; as a result, the direction in which the vibration plate 21 faces the shock wave transmission member 114 is also substantially perpendicular to the axial direction P1 of the invasive member 1, meaning the included angle R1 is substantially 90 degrees. Once the disk 2 is supplied with an electric signal, the vibration plate 21 is vibrated and generates shock waves. The shock waves propagate outward in a direction substantially perpendicular to the axial direction P1 of the invasive member 1 through the shock wave transmission medium 3 (e.g., water) and the shock waver transmission member 114 (e.g., silicone). The shock wave transmission medium 3 occupying the entire first receiving room 11151 not only transmits shock waves, but also can circulate through the first passage 14, thereby carrying away the heat generated by the disk 2 during operation, allowing the invasive shock wave applicator 9000 to dissipate heat effectively.

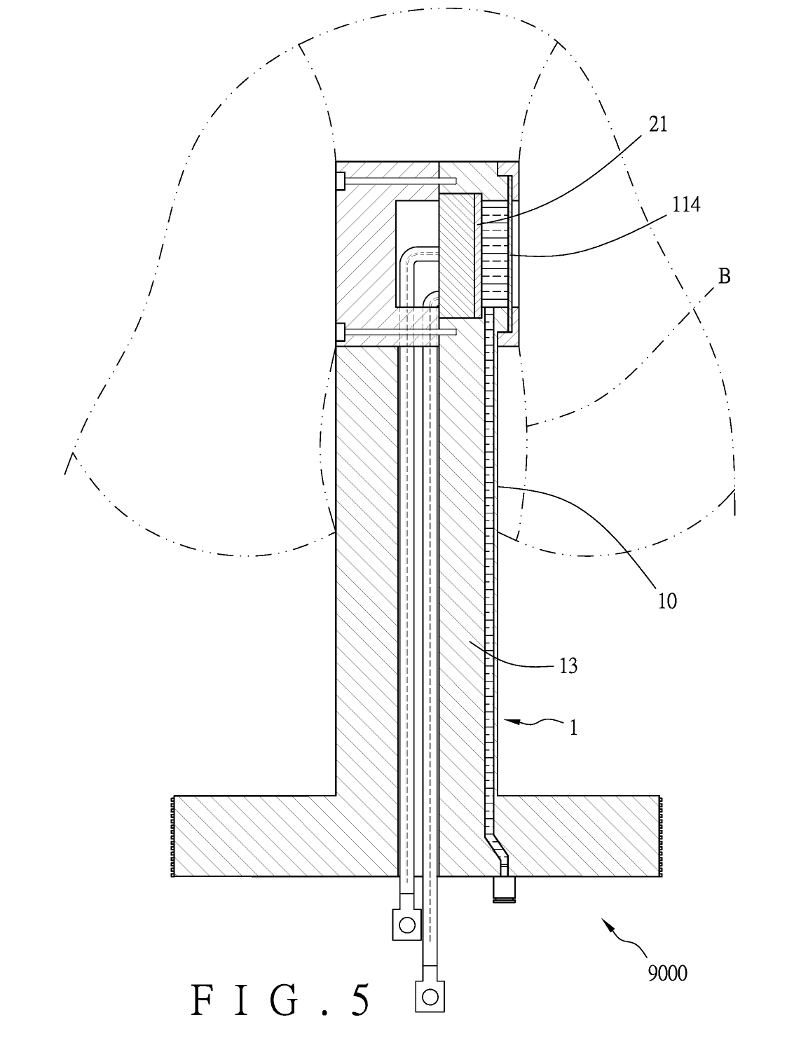

Referring to FIG. 5, the invasive shock wave applicator 9000 in this embodiment is compact in size and emits shock waves toward the lateral side 10. To perform an invasive shock wave treatment in a human cavity B of the human body, the operator places the invasive member 1 into the human cavity B and can adjust the position and direction the shock wave transmission member 114 faces in order to press the shock wave transmission member 114 tightly against the wall of the human cavity B and allow the shock wave transmission member 114 to transmit shock waves into the human body. In FIG. 5, a gynecological treatment, for urinary incontinence for example, is carried out by placing the invasive shock wave applicator 9000 into a woman's vagina. As the direction in which the vibration plate 21 faces the shock wave transmission member 114 is substantially perpendicular to the axial direction P1 of the invasive member 1, the operator can easily adjust the target and direction of shock waves generated by the invasive shock wave applicator 9000, in order to apply the shock waves to muscles neighboring the urinary organs.

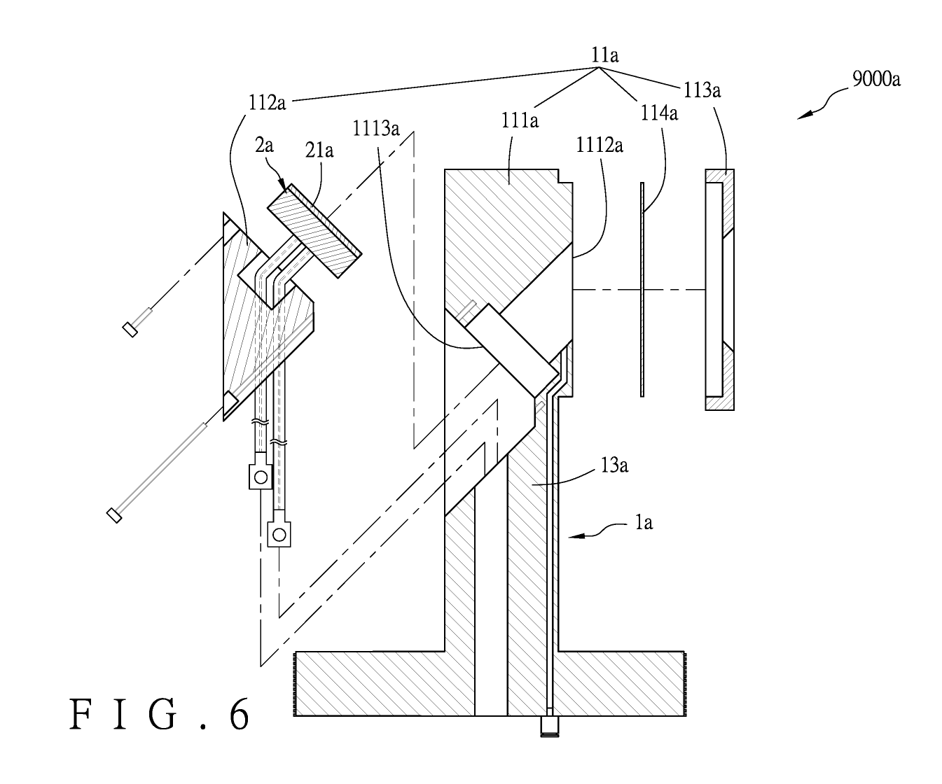

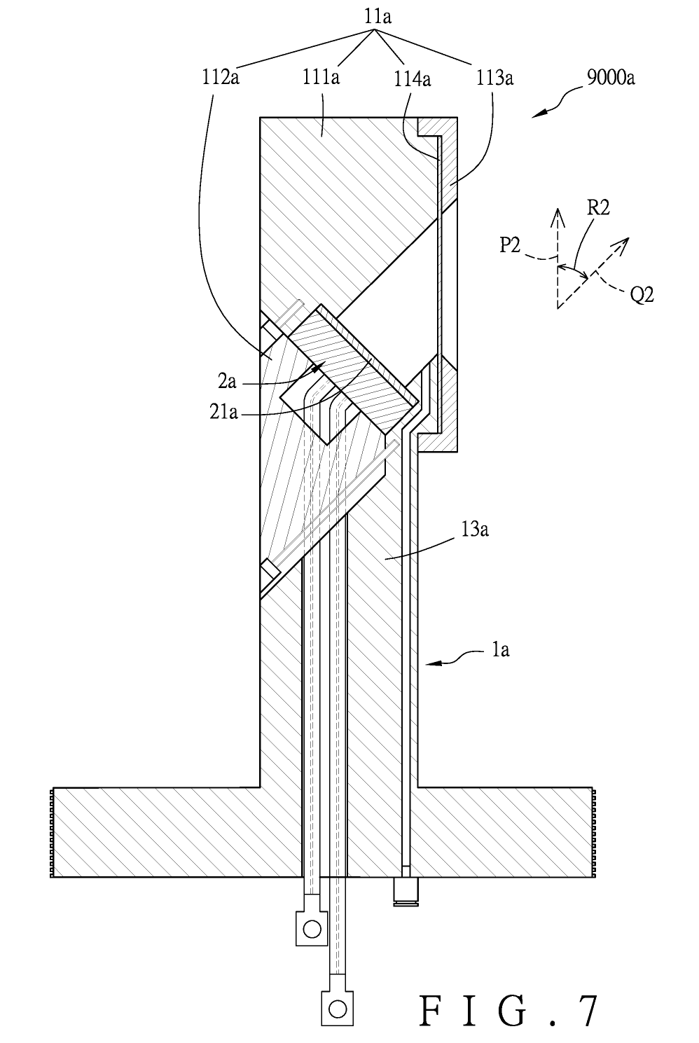

It should be pointed out that, referring to FIG. 6 and FIG. 7, the included angle between the shock wave transmission direction and the axial direction of the invasive member is not necessarily 90 degrees. In the embodiment shown in FIG. 6 and FIG. 7, for example, the invasive shock wave applicator 9000a for applying shock waves sideways has generally the same structure as its counterpart in the previous embodiment, except that the direction in which the aperture 1113a faces the opening 1112a, and consequently the direction in which the vibration plate 21a faces the shock wave transmission member 114a, are substantially at a 45-degree angle with respect to the axial direction P2 of the invasive member la, meaning the included angle R2 between the axial direction P2 and the first direction Q2 is substantially 45 degrees. With this configuration, the invasive shock wave applicator 9000a is equally applicable to treatments to be performed in a human cavity of the human body. Moreover, in each of the two embodiments described above, the disk 2 (2a) is fixed to the convex block 111 (111a) by the fixing block 112 (112a) such that the disk 2 (2a), the convex block 111 (111a), and the fixing block 112 (112a) are detachably assembled together to form the first end 11 (11a), which is integrally connected with the middle section 13 (13a) and functions as a shock wave generating unit for conducting invasive shock wave treatments in a human cavity of the human body. The assembled structure also facilitates component replacement and simplifies maintenance.

The foregoing description of the embodiments should be able to enable a full understanding of the operation, use, and effects of the present invention. It is understood, however, that the embodiments disclosed herein are only some preferred ones of the invention and are not intended to be restrictive of the scope of the invention. All simple equivalent changes and modifications made according to this specification and the appended claims should fall within the scope of the present invention.

What is claimed is:

1. An invasive shock wave applicator for applying shock waves sideways, comprising:
an invasive member extending in an axial direction and shaped as a bar, wherein the invasive member includes a lateral side and a first end, the first end is provided with a recess extending inward from the lateral side, the recess has an opening on the lateral side, the invasive member further has a second end opposite the first end, the second end is formed with a first passage and a second passage, both connected with the recess, and there is a shock wave transmission member detachably sealing the opening of the recess; and
a disk embedded in the invasive member and lying in the recess, wherein the disk divides the recess into a first receiving room adjacent to the shock wave transmission member and a second receiving room away from the shock wave transmission member, the first passage is in connect with the first receiving room, the second passage is connect with the second receiving room, the disk is provided with a vibration plate adjacent to the first receiving room and facing the shock wave transmission member, the vibration plate faces the shock wave transmission member in a direction defined as a first direction, the first direction and the axial direction form an included angle, the first receiving room is filled with a shock wave transmission medium able to circulate through the first passage, and there is an electrical connection member extending through the second passage and electrically connected to the disk.

2. The invasive shock wave applicator for applying shock waves sideways as claimed in claim 1, wherein the included angle ranges from 1 degree to 135 degrees.

3. The invasive shock wave applicator for applying shock waves sideways as claimed in claim 1, wherein the included angle is substantially 90 degrees.

4. The invasive shock wave applicator for applying shock waves sideways as claimed in claim 1, wherein the included angle is substantially 45 degrees.

5. The invasive shock wave applicator for applying shock waves sideways as claimed in claim 1, wherein the invasive member further includes a middle section connected between the first end and the second end, the first end includes a convex block and a fixing block, the convex block is integrally connected with the middle section, the fixing block is detachably assembled to the convex block, the convex block is penetrated by a channel and thus defines the opening and an aperture opposite the opening, the aperture is provided with an annular part, the disk is provided at the annular part and covers the aperture, and the disk is pressed tightly against the annular part when the fixing block is assembled to the convex block.

6. The invasive shock wave applicator for applying shock waves sideways as claimed in claim 5, wherein the aperture faces the opening in a direction substantially at a 90-degree angle with respect to the axial direction such that the included angle is substantially 90 degrees.

7. The invasive shock wave applicator for applying shock waves sideways as claimed in claim 5, wherein the aperture faces the opening in a direction substantially at a 45-degree angle with respect to the axial direction such that the included angle is substantially 45 degrees.

8. The invasive shock wave applicator for applying shock waves sideways as claimed in claim 1, wherein the shock wave transmission member is made of silicone.

9. The invasive shock wave applicator for applying shock waves sideways as claimed in claim 5, wherein the shock wave transmission member is made of silicone.

10. The invasive shock wave applicator for applying shock waves sideways as claimed in claim 1, wherein the shock wave transmission medium is water.

11. The invasive shock wave applicator for applying shock waves sideways as claimed in claim 5, wherein the shock wave transmission medium is water.

12. The invasive shock wave applicator for applying shock waves sideways as claimed in claim 1, wherein the first end further includes an annular lateral cover fixedly provided at the opening, and the shock wave transmission member is fixedly provided between the annular lateral cover and the opening.

13. The invasive shock wave applicator for applying shock waves sideways as claimed in claim 5, wherein the first end further includes an annular lateral cover fixedly provided at the opening, and the shock wave transmission member is fixedly provided between the annular lateral cover and the opening.
